(19) United States
(12) Patent Application Publication
(10) Pub. No.: US 2026/0067195 A1
(43) Pub. Date: Mar. 5, 2026

(54) NETWORK PERFORMANCE MONITORING WITH ACCESS LINK INFORMATION

(71) Applicant: Cisco Technology, Inc., San Jose, CA (US)

(72) Inventors: Filippo Ardito, Mont-sur-Rollem (CH); Nikhil Benjamin Pulimood, New York, NY (US); Ryan Michael Mack, Guilford, CT (US)

(73) Assignee: Cisco Technology, Inc., San Jose, CA (US)

(21) Appl. No.: 18/821,100

(22) Filed: Aug. 30, 2024

(51) Int. Cl. H04L 43/12; H04L 43/0811

(52) U.S. Cl. CPC H04L 43/12; H04L 43/0811

(57) ABSTRACT

In one implementation, a device receives a control request from an endpoint agent executed by a wireless endpoint in a network. The device generates, based on the control request, a configuration for a particular port on an access point to which the wireless endpoint is connected. The device notifies the endpoint agent of the particular port via which the endpoint agent may perform path probing in the network. The device removes the configuration after the endpoint agent performs the path probing via the particular port.

### TECHNICAL FIELD

The present disclosure relates generally to computer networks and more particularly to network performance monitoring with access link information.

### BACKGROUND

As computer networks become increasingly complex, network observability has taken on an important role for purposes such as ensuring service level agreements (SLAs) are met, identifying network issues, and the like. To this end, active network performance monitoring (ANPM) serves to test the end-to-end Layer-3 connectivity to a target destination. For instance, an ANPM agent may send test packets using the Internet Control Message Protocol (ICMP) and/or rely on time-to-live (TTL) values, to learn about the network path to the target destination.

However, ANPM today does not provide any visibility into the Layer-2 hops traversed by the test packets. This is particularly true in the case of wireless networks whereby a wireless endpoint forms a Layer-2 access link with a nearby access point. Such links could add delays and other impairments to the end-to-end path measurements and are hard to pin down with purely Layer-3 path testing.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example observability intelligence platform;

FIG. 4 illustrates an example display of network path information;

FIG. 5 illustrates an example wireless network;

FIG. 6 illustrates an example of a wireless endpoint probing a network path;

FIG. 7 illustrates an example flow diagram for network performance monitoring with access link information; and

FIG. 8 illustrates an example simplified procedure for network performance monitoring with access link information, in accordance with one or more implementations described herein.

### DESCRIPTION OF EXAMPLE IMPLEMENTATIONS

### Overview

According to one or more implementations of the disclosure, a device receives a control request from an endpoint agent executed by a wireless endpoint in a network. The device generates, based on the control request, a configuration for a particular port on an access point to which the wireless endpoint is connected. The device notifies the endpoint agent of the particular port via which the endpoint agent may perform path probing in the network. The device removes the configuration after the endpoint agent performs the path probing via the particular port.

Other implementations are described below, and this overview is not meant to limit the scope of the present disclosure.

### DESCRIPTION

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

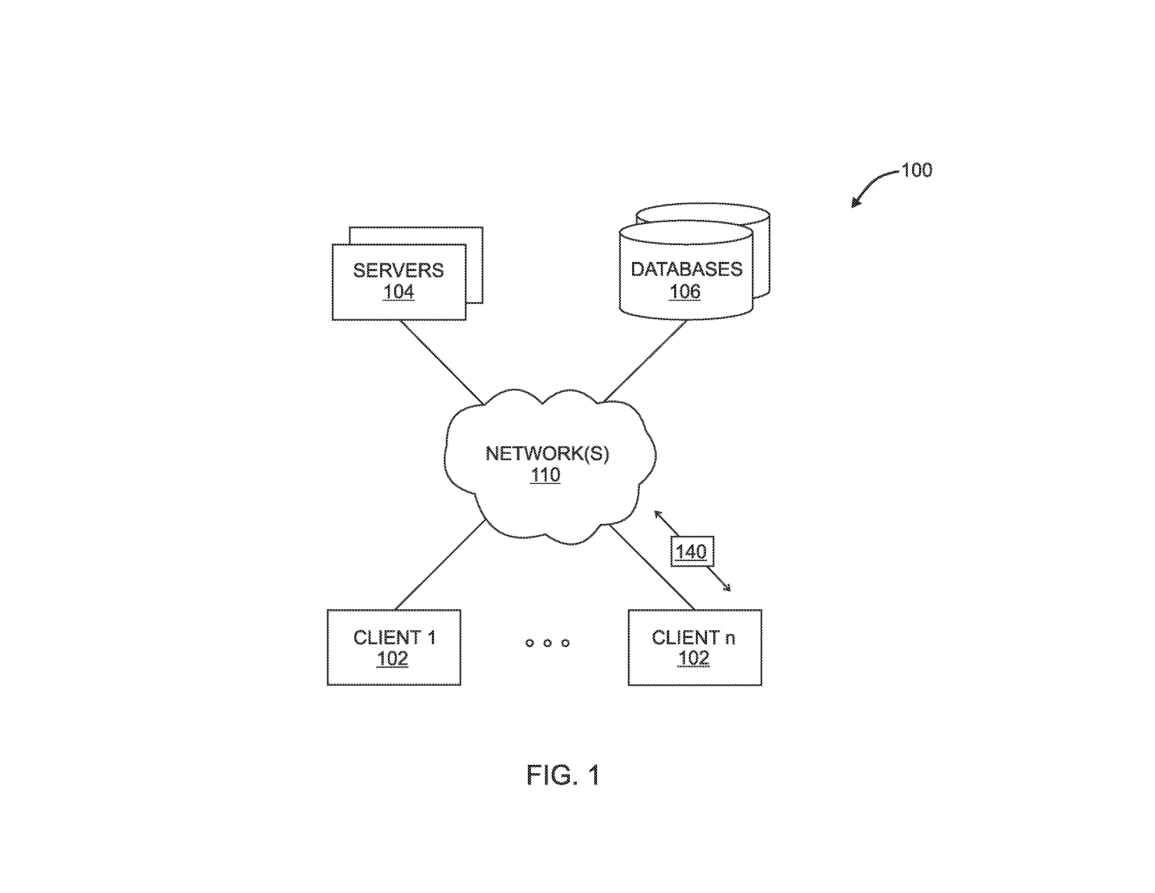

FIG. 1 is a schematic block diagram of an example simplified computing system (e.g., the computing system 100), which includes client devices 102 (e.g., a first through nth client device), one or more servers 104, and databases 106 (e.g., one or more databases), where the devices may be in communication with one another via any number of networks (e.g., network(s) 110). The network(s) 110 may include, as would be appreciated, any number of specialized networking devices such as routers, switches, access points, etc., interconnected via wired and/or wireless connections. For example, client devices 102, the one or more servers 104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, the one or more servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user’s data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

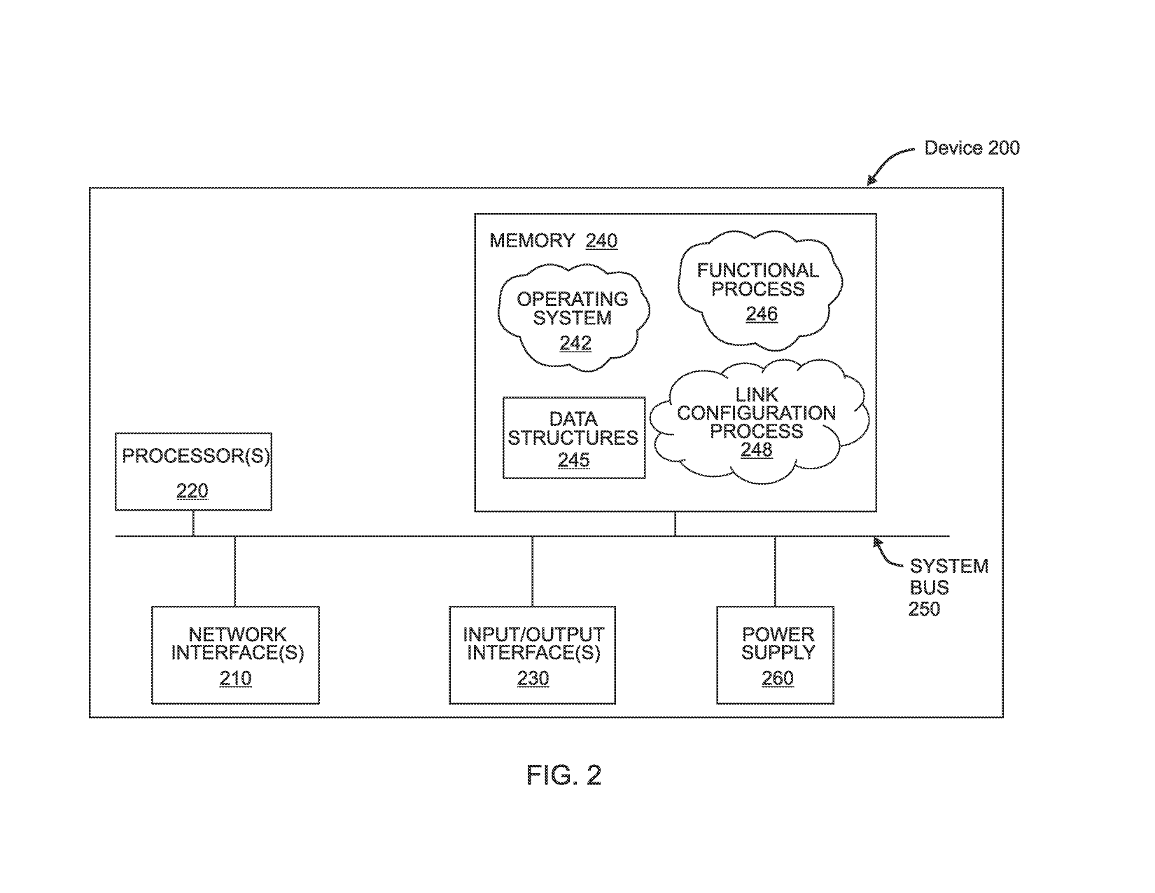

FIG. 2 is a schematic block diagram of an example node/device 200 (e.g., an apparatus) that may be used with one or more implementations described herein, e.g., as any of the devices shown in FIG. 1 above. Device 200 may comprise one or more network interfaces, such as interfaces 210 (e.g., wired, wireless, network interfaces, etc.), at least one processor (e.g., processor 220), and a memory 240 interconnected by a system bus 250, as well as a power supply 260 (e.g., battery, plug-in, etc.).

The interfaces 210 contain the mechanical, electrical, and signaling circuitry for communicating data over links coupled to the network(s) 110. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the interfaces 210 for storing software programs and data structures associated with the implementations described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise a one or more functional processes (e.g., functional processes 246), and on certain devices, an illustrative process such as link configuration process 248, as described herein. Notably, functional processes 246, when executed by processor 220, cause each device 200 to perform the various functions corresponding to the particular device’s purpose and general configuration. For example, a router would be configured to operate as a router, a server would be configured to operate as a server, an access point (or gateway) would be configured to operate as an access point (or gateway), a client device would be configured to operate as a client device, and so on.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, link configuration process 248 may include computer executable instructions that, when executed by processor 220, cause device 200 to perform the techniques described herein. To do so, in some implementations, link configuration process 248 may utilize and/or be a component of machine learning implementations. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M = a*x + b*y + c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, link configuration process 248 may employ and/or be utilized to handle prompts to and/or access of one or more supervised, unsupervised, or semi-supervised machine learning models. Generally, supervised learning entails the use of a training set of data that is used to train the model to apply labels to the input data. For example, the training data may include sample configurations labeled with textual metadata. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that the link configuration process 248 can employ and/or be utilized in concert with may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), generative adversarial networks (GANs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, link configuration process 248 may also include, or otherwise use or be employed to operate with, one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of configuring an observability platform to perform certain application analytics, link configuration process 248 may be a component of, use, and/or be utilized in the management of prompts/access to a generative model to perform network mapping, generate configurations, perform analyses, perform root cause analysis, or other outputs based on a conversational input from a user (e.g., voice, text, etc.). In another example, link configuration process 248 may utilize a generative model with a method invocation data collector (MIDC) to assist in automated or manual identification of transactional attributes for spans. Example generative approaches can include, but are not limited to, generative adversarial networks (GANs), large language models (LLMs), other transformer models, and the like.

The performance of a machine learning model can be evaluated in a number of ways based on the number of true positives, false positives, true negatives, and/or false negatives of the model. For example, consider the case of a model that predicts whether the QoS of a path will satisfy the service level agreement (SLA) of the traffic on that path. In such a case, the false positives of the model may refer to the number of times the model incorrectly predicted that the QoS of a particular network path will not satisfy the SLA of the traffic on that path. Conversely, the false negatives of the model may refer to the number of times the model incorrectly predicted that the QoS of the path would be acceptable. True negatives and positives may refer to the number of times the model correctly predicted acceptable path performance or an SLA violation, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

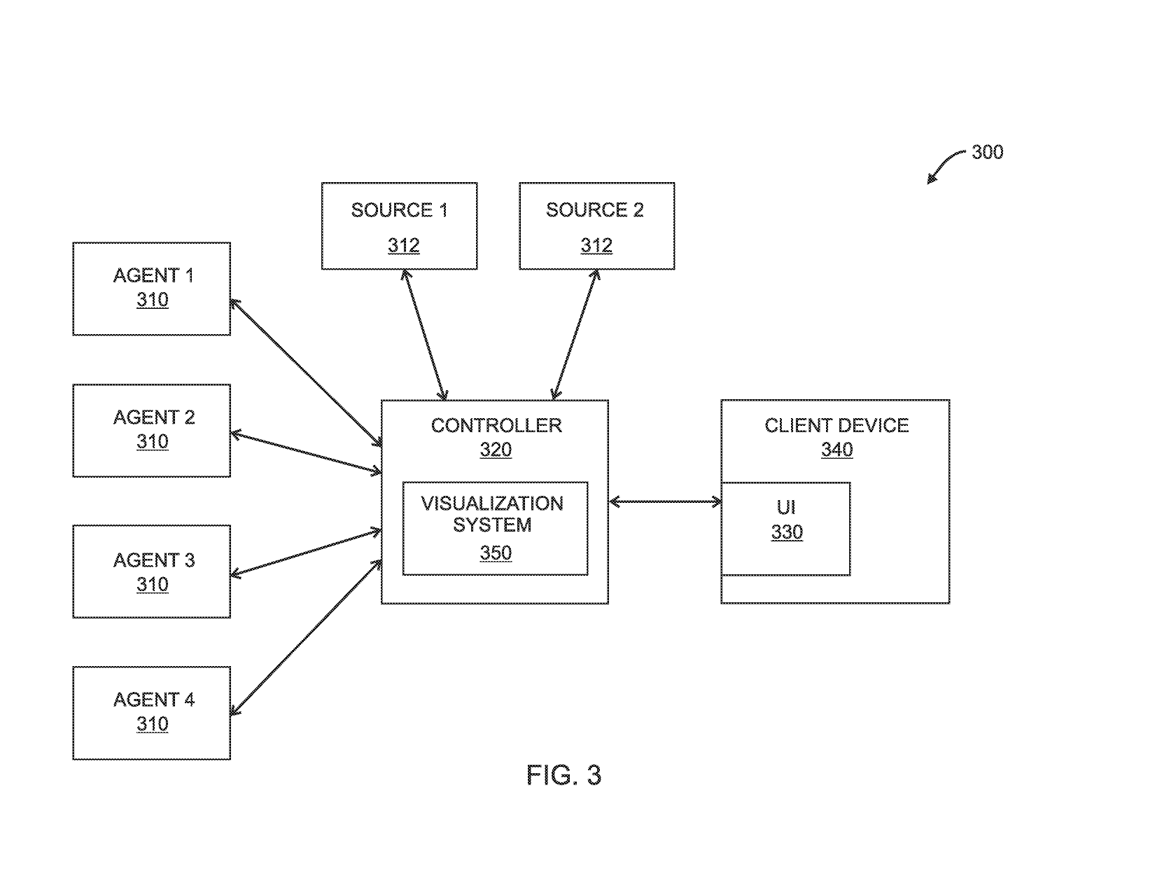

FIG. 3 is a block diagram of an example of an observability intelligence platform 300 that can implement one or more aspects of the techniques herein. The observability intelligence platform 300 is a system that monitors and collects metrics of performance data for a network and/or application environment being monitored. At the simplest structure, the observability intelligence platform 300 includes one or more agents (e.g., agents 310), one or more sources (e.g., sources 312), and one or more servers/controllers (e.g., controller 320). Agents may be installed on network browsers, devices, servers, etc., and may be executed to monitor the associated device and/or application, the operating system of a client, and any other application, API, or another component of the associated device and/or application, and to communicate with (e.g., report data and/or metrics to) the controller 320 as directed. Note that while FIG. 3 shows four agents (e.g., Agent 1 through Agent 4) communicatively linked to a single controller, the total number of agents and controllers can vary based on a number of factors including the number of networks and/or applications monitored, how distributed the network and/or application environment is, the level of monitoring desired, the type of monitoring desired, the level of user experience desired, and so on.

For example, instrumenting an application with agents may allow a controller to monitor performance of the application to determine such things as device metrics (e.g., type, configuration, resource utilization, etc.), network browser navigation timing metrics, browser cookies, application calls and associated pathways and delays, other aspects of code execution, etc. Moreover, if a customer uses agents to run tests, probe packets may be configured to be sent from agents to travel through the Internet, go through many different networks, and so on, such that the monitoring solution gathers all of the associated data (e.g., from returned packets, responses, and so on, or, particularly, a lack thereof). Such probing may be performed for purposes of capturing path performance metrics (e.g., delay, loss, jitter, etc.) and/or to trace the path in an attempt to identify its constituent hops. Typically, path tracing entails sending packets in a suitable protocol such as the Internet Control Message Protocol (ICMP), TCP, or the like, with different time-to-live (TTL) values, causing the different hops along the path to respond back when a given packet times out.

The controller 320 is the central processing and administration server for the observability intelligence platform 300. The controller 320 may serve a user interface 330 (denoted UI in FIG. 3), such as a browser-based UI, that is the primary interface for monitoring, analyzing, and troubleshooting the monitored environment. Specifically, the controller 320 can receive data from agents 310, sources 312 (and/or other coordinator devices), associate portions of data (e.g., topology, transaction end-to-end paths and/or metrics, etc.), communicate with agents to configure collection of the data (e.g., the instrumentation/tests to execute), and provide performance data and reporting through user interface 330. User interface 330 may be viewed as a web-based interface viewable by a client device 340. In some implementations, a client device 340 can directly communicate with controller 320 to view an interface for monitoring data. The controller 320 can include a visualization system 350 for displaying the reports and dashboards related to the disclosed technology. In some implementations, the visualization system 350 can be implemented in a separate machine (e.g., a server) different from the one hosting the controller 320.

Notably, in an illustrative Software as a Service (SaaS) implementation, an instance of controller 320 may be hosted remotely by a provider of the observability intelligence platform 300. In an illustrative on-premises (On-Prem) implementation, a controller 320 may be installed locally and self-administered.

The controllers 320 receive data from the agents 310 (e.g., Agents 1-4) and/or sources 312 deployed to monitor networks, applications, databases and database servers, servers, and end user clients for the monitored environment. Any of the agents 310 can be implemented as different types of agents with specific monitoring duties. For example, application agents may be installed on each server that hosts applications to be monitored. Instrumenting an agent adds an application agent into the runtime process of the application. Further, the controllers 320 can receive data from sources 312 (e.g., sources 1-2). Any of the sources can be implemented to provide various types of observability data that can include information, metrics, telemetry data, business data, network data, etc.

In accordance with certain implementations, both self-learned baselines and configurable thresholds may be used to help identify network and/or application issues. A complex distributed application, for example, has a large number of performance metrics and each metric is important in one or more contexts. In such environments, it is difficult to determine the values or ranges that are normal for a particular metric; set meaningful thresholds on which to base and receive relevant alerts; and determine what is a “normal” metric when the application or infrastructure undergoes change. For these reasons, the disclosed observability intelligence platform can perform anomaly detection based on dynamic baselines or thresholds, such as through various machine learning techniques, as may be appreciated by those skilled in the art. For example, the illustrative observability intelligence platform herein may automatically calculate dynamic baselines for the monitored metrics, defining what is “normal” for each metric based on actual usage. The observability intelligence platform may then use these baselines to identify subsequent metrics whose values fall out of this normal range.

In general, data/metrics collected relate to the topology and/or overall performance of the network and/or application (or application transaction) or associated infrastructure, such as, e.g., path loss, path jitter, path delays, average response time, error rate, percentage CPU busy, percentage of memory used, etc. The controller UI can thus be used to view all of the data/metrics that the agents report to the controller, as topologies, heatmaps, graphs, lists, and so on. Illustratively, data/metrics can be accessed programmatically using a Representational State Transfer (REST) API (e.g., that returns either the JavaScript Object Notation (JSON) or the eXtensible Markup Language (XML) format). Also, the REST API can be used to query and manipulate the overall observability environment.

Those skilled in the art will appreciate that other configurations of observability intelligence may be used in accordance with certain aspects of the techniques herein, and that other types of agents, instrumentations, tests, controllers, and so on may be used to collect data and/or metrics of the network(s) and/or application(s) herein. Also, while the description illustrates certain configurations, communication links, network devices, and so on, it is expressly contemplated that various processes may be implemented across multiple devices, on different devices, utilizing additional devices, and so on, and the views shown herein are merely simplified examples that are not meant to be limiting to the scope of the present disclosure.

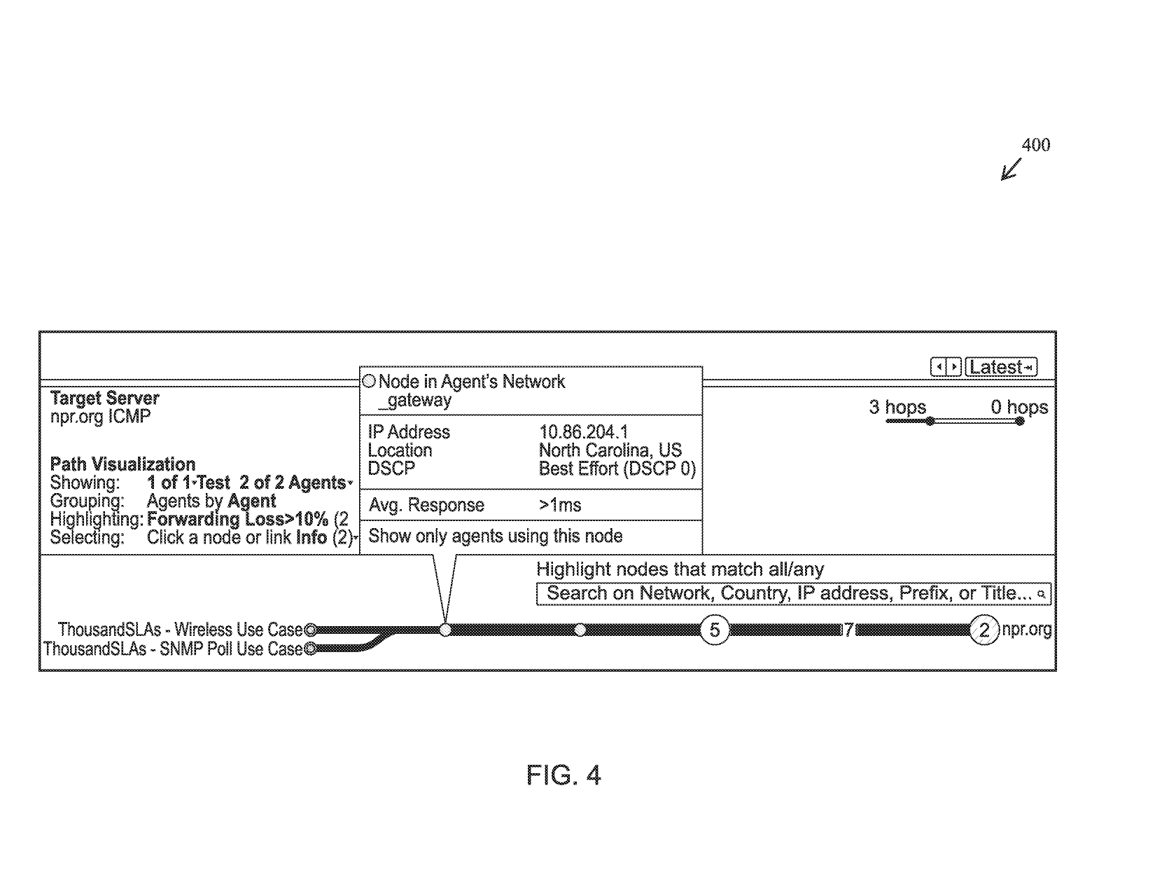

By way of example, FIG. 4 illustrates an example display 400 of network path information that may be captured by one or more agents (e.g., agents 310) performing path probing with respect to a target server (e.g., npr.org) using ICMP probe packets. This allows the system to capture information about the various hops along the path, such as the network gateway shown. In addition, display 400 may also present the path metrics between the endpoint agents and the various hops (e.g., the average delay/response time to the gateway is less than 1 ms).

As noted above, while ANPM agents today are quite capable of capturing observability information about a network path such as its performance metrics, hop information, etc., they only provide Layer-3 visibility into the path. Often, though, poor path performance metrics are due to the Layer-2 access link between an endpoint agent and its local network, thereby affecting the end-to-end path performance metrics. This means that the observability platform will be unable to pinpoint that wireless link as the cause of the degraded performance.

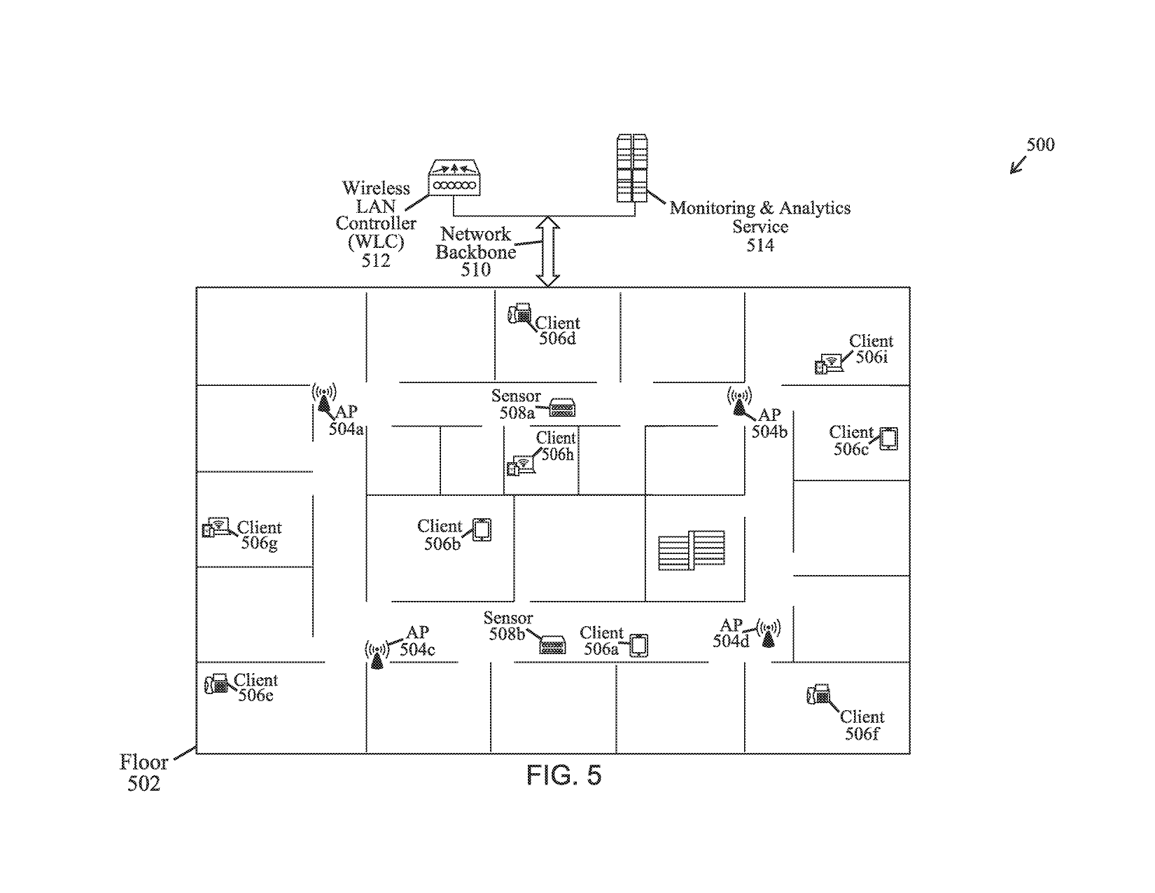

FIG. 5 illustrates an example wireless network 500, according to various embodiments. Wireless network 500 may include any number of physical locations, such as floor 502 shown, and may include various infrastructure devices. These infrastructure devices may include, for example, one or more access points (APs) 504 that provide wireless connectivity to the various wireless clients 506 distributed throughout the location. For illustrative purposes, APs 504a-504d and clients 506a-506i are depicted in FIG. 5. However, as would be appreciated, a wireless network deployment may include any number of APs and clients.

A network backbone 510 may interconnect APs 504a-504d and provide a connection between APs 504a-504d and any number of supervisory devices or services that provide control over APs 504a-504d. For example, as shown, a wireless LAN controller (WLC) 512 may control some or all of APs 504a-504d, by setting their control parameters (e.g., max number of attached clients, channels used, wireless modes, etc.). Another supervisory service that oversees the wireless network in wireless network 500 may be a monitoring and analytics service 514 that measures and monitors the performance of the wireless network in wireless network 500 and, if so configured, may also adjust the operation of the wireless network based on the monitored performance (e.g., via WLC 512, etc.).

Network backbone 510 may further provide connectivity between the infrastructure of the local network and a larger network, such as the Internet, a Multiprotocol Label Switching (MPLS) network, or the like. Accordingly, WLC 512 and/or monitoring and analytics service 514 may be located on the same local network as APs 504 or, alternatively, may be located remotely, such as in a remote datacenter, in the cloud, etc. To provide such connectivity, network backbone 510 may include any number of wired connections (e.g., Ethernet, optical, etc.) and/or wireless connections (e.g., cellular, etc.), as well as any number of networking devices (e.g., routers, switches, etc.).

In some embodiments, the wireless network in wireless network 500 may also include any number of wireless network sensors 508, such as network sensors 508a-508b shown. In general, “wireless network sensors” are specialized devices that are able to act as wireless clients and perform testing on the wireless network in wireless network 500 and are not to be confused with other forms of sensors that may be distributed throughout a wireless network, such as motion sensors, temperature sensors, etc. In some cases, any of APs 504a-504d can also act as a wireless network sensor, by emulating a client in the network for purposes of testing communications with other APs. Thus, emulation points in the wireless network may include dedicated wireless network sensors 508 and/or APs 504, if so configured.

The types and configurations of wireless clients 506 in the network in wireless network 500 can vary greatly. For example, clients 506a-506c may be mobile phones, clients 506d-506f may be office phones, and clients 506g-506i may be computers, all of which may be of different makes, models, and/or configurations (e.g., firmware or software versions, chipsets, etc.). Consequently, each of clients 506a-506i may behave very differently in the wireless network from both radio frequency (RF) and traffic perspectives. In addition, while wireless network 500 is shown as comprising a wireless network, it should be appreciated that it may also include one or more wired networks, as well (e.g., an Ethernet-based network, etc.).

In the case of a given wireless endpoint/client in wireless network 500 executing an ANPM agent (e.g., an agent 310) configured to send path probes towards a target destination, such path probing will not capture information regarding the access link between that client and its access point. For instance, assume that and endpoint agent on client 506g probes the path to a cloud server via AP 504a, network backbone 510, etc. If the link between client 506g and AP 504a exhibits poor performance, the end-to-end performance metrics between client 506g and the cloud server will also indicate poor performance. However, since the probing did not capture any information about the Layer-2 link, making it challenging to identify the cause of the poor path performance.

### Network Performance Monitoring with Access Link Information

In contrast, the techniques described herein provide observability and measurement of ANPM to the access device of a Layer-3 connection to a remote target, that allows to narrow down performance issues to the first Layer-2 link, e.g., to the wireless domain, that would otherwise be impossible to obtain. Doing so allows network administrators to identify and resolve performance issues at this level.

Illustratively, the techniques described herein may be performed by hardware, software, and/or firmware, such as in accordance with link configuration process 248, which may include computer executable instructions executed by the processor 220 (or independent processor of interfaces 210) to perform functions relating to the techniques described herein.

Specifically, according to various implementations, a device receives a control request from an endpoint agent executed by a wireless endpoint in a network. The device generates, based on the control request, a configuration for a particular port on an access point to which the wireless endpoint is connected. The device notifies the endpoint agent of the particular port via which the endpoint agent may perform path probing in the network. The device removes the configuration after the endpoint agent performs the path probing via the particular port.

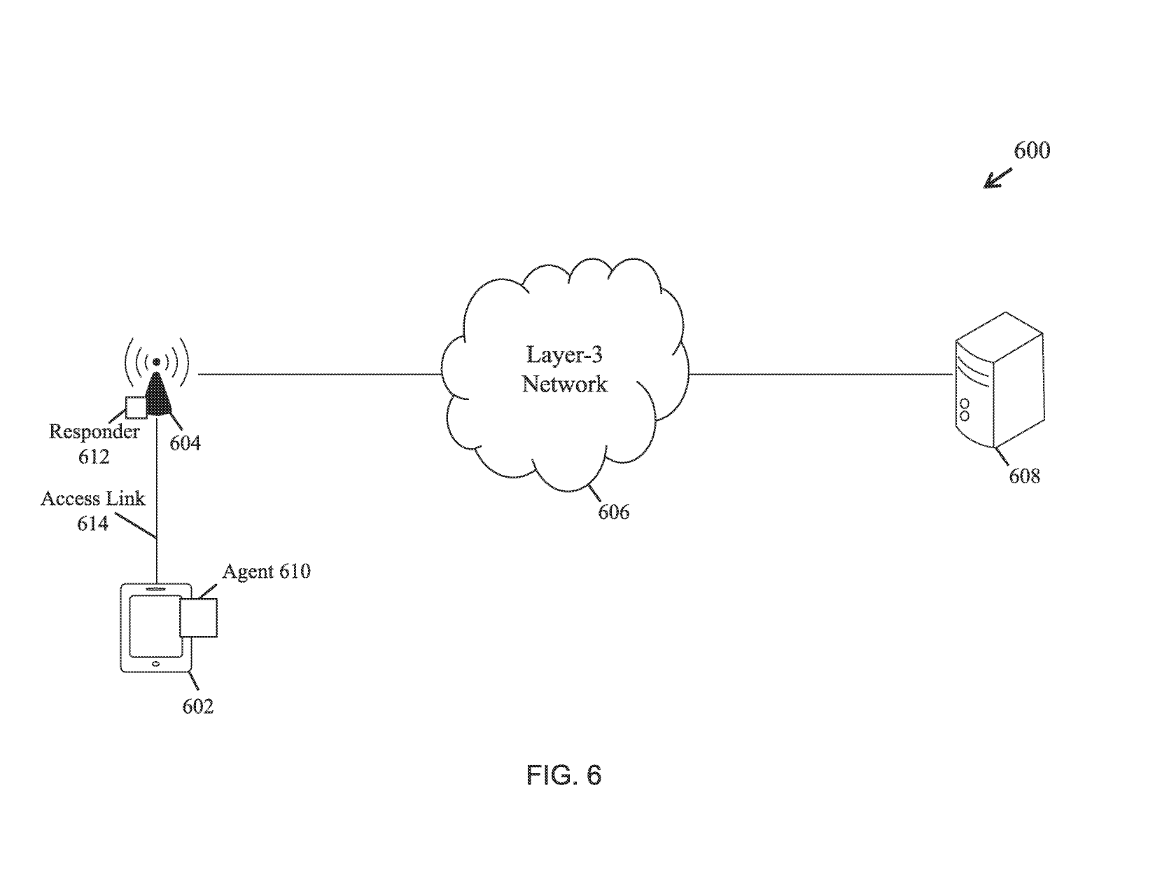

Operationally, FIG. 6 illustrates an example 600 of a wireless endpoint probing a network path, in various implementations. As shown, consider the case of a wireless endpoint 602 that shares an access link 614 with an AP 604. Wireless endpoint 602 may also execute an endpoint agent 610 configured to perform path probing. For instance, during such probing, wireless endpoint 602 may send probe packets towards a target destination 608 via AP 604 and a Layer-3 network 606.

In some implementations, AP 604 may likewise host a Layer-3 responder 612. For instance, responder 612 may take the form of an IPSLA or Two-Way Measurement Protocol (TWAMP) responder embedded on AP 604. Further implementations provided for responder 612 to be embedded elsewhere. For instance, responder 612 could also be implemented on a wired Layer-2 access devices. In one implementation, responder 612 may be managed by the WLC in the local network.

In various implementations, to capture information regarding access link 614 for use in combination with the path information obtained by sending probes towards target destination 608, endpoint agent 610 may target active probe traffic to a particular port of AP 604. In turn, responder 612 may listen on that port. If AP 604 classifies the source (i.e., wireless endpoint 602) as one of its active, connected, and authenticated clients, it may forward the packet to responder 612 for local processing, rather than passing it onward to the switch to which AP 604 is connected.

In turn, responder 612 may loopback the synthetic probe packets to endpoint agent 610, adding information to it, such as a timestamp indicative of when AP 604 received the packet, a timestamp indicative of when AP 604 sent the packet back towards wireless endpoint 602, and/or any other information that would allow endpoint agent 610 to capture performance information regarding access link 614. For instance, endpoint agent 610 could use such timestamps to derive the latency, which could even include one-way latency if the clocks of wireless endpoint 602 and AP 604 are in sync, the jitter, and/or the loss specific to access link 614.

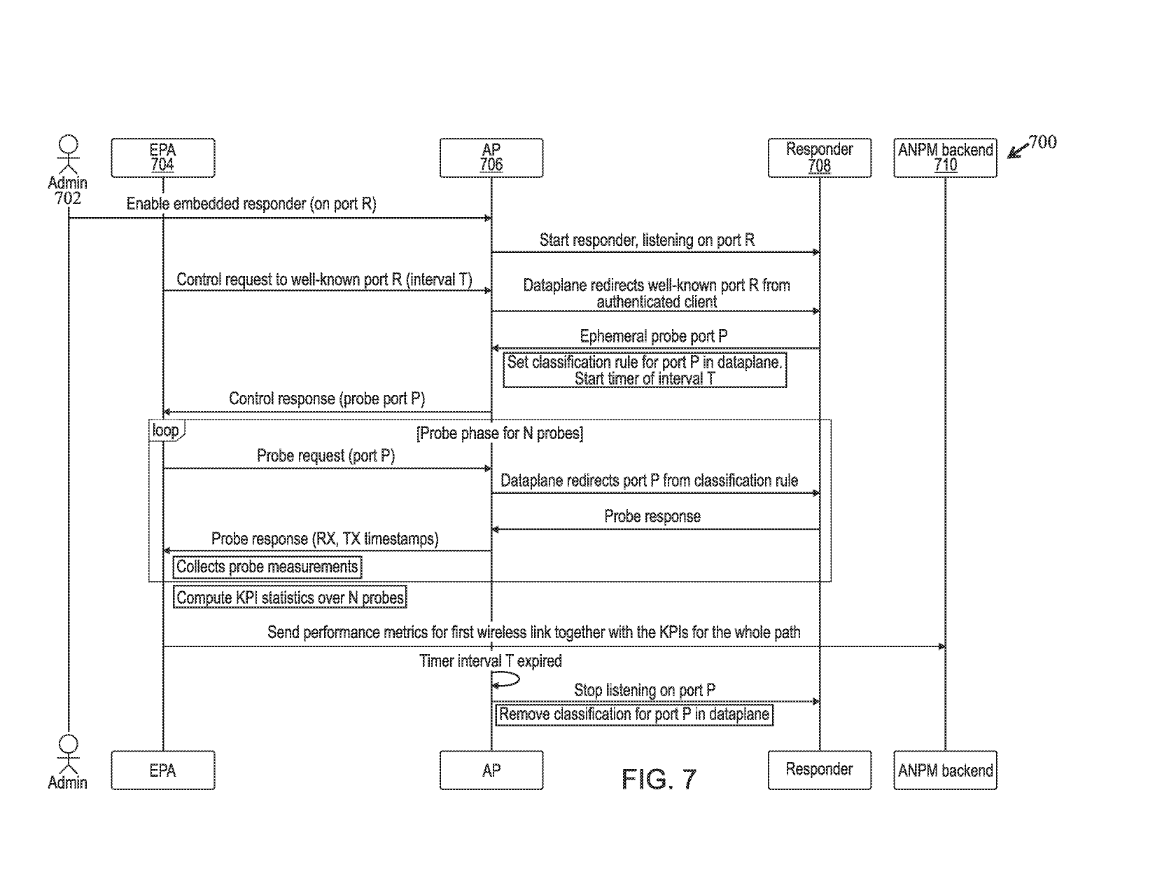

FIG. 7 illustrates an example flow diagram 700 for network performance monitoring with access link information, in various implementations. As shown, there may be the following entities involved: a network administrator 702, an endpoint agent 704 (EPA) executed by a wireless endpoint, an AP 706, a responder 708 hosted by AP 706, and an ANPM backend 710.

As shown, network administrator 702 may enable responder 708 on AP 706 on a certain port R. For instance, network administrator 702 may do so via the WLC in the network or other controller for AP 706. In turn, AP 706 may start responder 708, if not already started, which listens on port R. Generally, port R may serve as a well-known port used by any endpoint agent in the wireless network for purposes of initiating probing of an access link with AP 706.

When endpoint agent 704 is to conduct probing, it may send a control request to port R of AP (e.g., using the ANPM protocol). In some implementations, such a control request may also include a requested time interval T during which endpoint agent 704 wishes to conduct probing. Endpoint agent 704 may also include any other requested parameters in the payload of the control request, as well.

AP 706 detects the control request, which may take the form of an incoming Layer-2 frame, and first ensure that it was sent by an authenticated, active client of AP 706 (e.g., based on its MAC address). If so, AP 706 may forward the control request to responder 708 running locally on AP 706. In some implementations, AP 706 does not forward this traffic to the upstream switch to which it is attached.

In response to the control request, responder 708 may open a socket listening on an ephemeral probe port P of AP 706. In addition, responder 708 may start a timer in accordance with the probe interval indicated by the control request. In other implementations, responder 708 may set the timer according to a pre-set value, a default value, based on other information in the payload of the control request, or based on the identity of the is started for the probe interval period received. As part of the configuration of port P, responder 708 may also set the classification rule for port P in the dataplane.

Once port P is configured, responder 708 may then send a control response to endpoint agent 704 with the identity of port P. From the standpoint of endpoint agent 704, this exchange also allows it to check whether AP 706 is indeed running a responder (e.g., responder 708), as configured by the network administrator.

In turn, endpoint agent 704 may then being conducting probing via port P of AP 706. When the dataplane of AP 706 receives such follow-up ANPM probe traffic, per the specific embedded ANPM protocol, it may redirect the probes to responder 708. This traffic is not forwarded anywhere else outside of the AP 706, in some implementations.

Responder 708 then prepares and sends a probe response back to endpoint agent 704. For instance, responder 708 may include timestamps in the response indicative of when AP 706 received the corresponding probe packet from endpoint agent 704 and/or when AP 706 sent the response back to endpoint agent 704. This allows endpoint agent 704 to compute metrics (e.g., key performance indicator (KPI) statistics) for the link between the endpoint and AP 706, such as the one way and/or round trip latencies/delays, packet loss, jitter, etc. In the case of jitter, endpoint agent 704 and responder 708 may repeat this probing exchange multiple times.

When endpoint agent 704 completes its probing of the link with AP 706, the probe phase is complete. Endpoint agent 704 may then send the performance metrics for the first wireless link with AP 706 together with the KPIs for the whole path (e.g., between the endpoint and the target destination, such as a server or service) to ANPM backend 710.

When the ANPM probe interval timer expires, responder 708 may then remove the ephemeral port P from the dataplane redirect configuration of AP 706. It may also close the socket listening on the probe port.

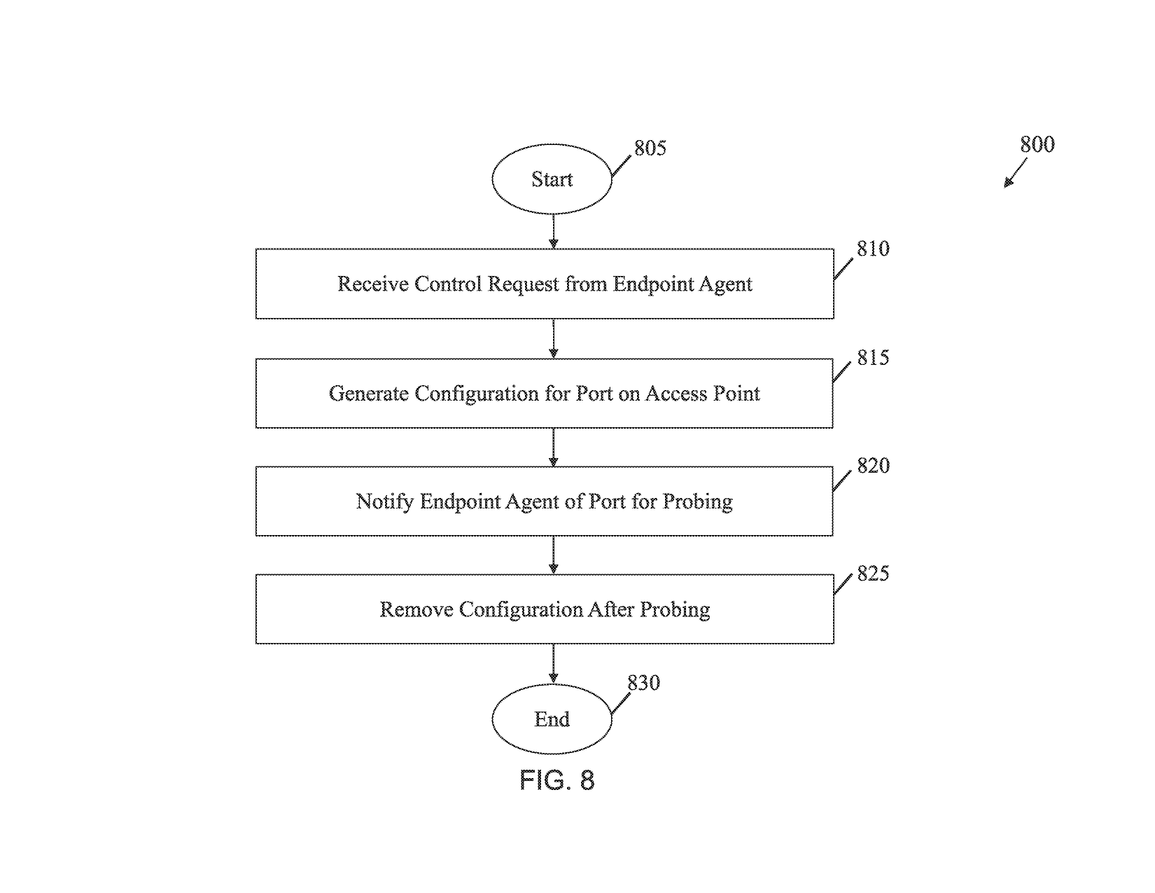

FIG. 8 illustrates an example flow diagram for network performance monitoring with access link information, in accordance with one or more implementations described herein. For example, a non-generic, specifically configured device (e.g., device 200), may perform procedure 800 (e.g., a method) by executing stored instructions (e.g., link configuration process 248). The procedure 800 may start at step 805, and continues to step 810, where, as described in greater detail above, the device (e.g., a controller, a server, an access point, etc.) may receive a control request from an endpoint agent executed by a wireless endpoint in a network. In various implementations, the device receives the control request via a different port than that of the particular port.

At step 815, as detailed above, the device may generate, based on the control request, a configuration for a particular port on an access point to which the wireless endpoint is connected. In some implementations, the device generates the configuration as a classification rule for the particular port that redirects the path probing from the wireless endpoint to a probing responder. In one implementation, the device generates the configuration based in part on the wireless endpoint being an authenticated and active client of the access point.

At step 820, the device may notify the endpoint agent of the particular port via which the endpoint agent may perform path probing in the network, as described in greater detail above. In some implementations, the path probing captures performance metrics regarding a Layer-2 link between the wireless endpoint and the access point. In an additional implementation, the path probing further captures performance metrics regarding a path in the network between the wireless endpoint and a target destination that includes the Layer-2 link. In one implementation, the endpoint agent performing path probing comprises conducting Two-Way Active Measurement Protocol (TWAMP) probing. In various instances, the endpoint agent, based on its path probing, computes at least one of: a packet loss metric, a jitter metric, or a delay metric.

At step 825, as detailed above, the device may remove the configuration after the endpoint agent performs the path probing via the particular port. In various implementations, the device removes the configuration after expiration of a timer associated with the configuration.

Procedure 800 may then end at step 835.

It should be noted that while certain steps within procedure 800 may be optional as described above, the steps shown in FIG. 8 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

While there have been shown and described illustrative implementations that provide for network performance monitoring with access link information, it is to be understood that various other adaptations and modifications may be made within the intent and scope of the implementations herein. In addition, while certain processes are shown, other suitable processes may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

1. A method, comprising:
receiving, at a device, a control request from an endpoint agent executed by a wireless endpoint in a network;
generating, by the device and based on the control request, a configuration for a particular port on an access point to which the wireless endpoint is connected;
notifying, by the device, the endpoint agent of the particular port via which the endpoint agent may perform path probing in the network; and
removing, by the device, the configuration after the endpoint agent performs the path probing via the particular port.

2. The method as in claim 1, wherein the path probing captures performance metrics regarding a Layer-2 link between the wireless endpoint and the access point.

3. The method as in claim 2, wherein the path probing further captures performance metrics regarding a path in the network between the wireless endpoint and a target destination that includes the Layer-2 link.

4. The method as in claim 1, wherein the device receives the control request via a different port than that of the particular port.

5. The method as in claim 1, wherein the device removes the configuration after expiration of a timer associated with the configuration.

6. The method as in claim 1, wherein the device generates the configuration as a classification rule for the particular port that redirects the path probing from the wireless endpoint to a probing responder.

7. The method as in claim 1, wherein the endpoint agent performing path probing comprises conducting Two-Way Active Measurement Protocol (TWAMP) probing.

8. The method as in claim 1, wherein the device generates the configuration based in part on the wireless endpoint being an authenticated and active client of the access point.

9. The method as in claim 8, wherein the endpoint agent, based on its path probing, computes at least one of: a packet loss metric, a jitter metric, or a delay metric.

10. The method as in claim 1, wherein the device is the access point.

11. An apparatus, comprising:
one or more network interfaces;
a processor coupled to the one or more network interfaces and configured to execute one or more processes; and
a memory configured to store a process that is executable by the processor, the process when executed configured to:
receive a control request from an endpoint agent executed by a wireless endpoint in a network;
generate, based on the control request, a configuration for a particular port on an access point to which the wireless endpoint is connected;
notify the endpoint agent of the particular port via which the endpoint agent may perform path probing in the network; and
remove the configuration after the endpoint agent performs the path probing via the particular port.

12. The apparatus as in claim 11, wherein the path probing captures performance metrics regarding a Layer-2 link between the wireless endpoint and the access point.

13. The apparatus as in claim 12, wherein the path probing further captures performance metrics regarding a path in the network between the wireless endpoint and a target destination that includes the Layer-2 link.

14. The apparatus as in claim 11, wherein the apparatus receives the control request via a different port than that of the particular port.

15. The apparatus as in claim 11, wherein the apparatus removes the configuration after expiration of a timer associated with the configuration.

16. The apparatus as in claim 11, wherein the apparatus generates the configuration as a classification rule for the particular port that redirects the path probing from the wireless endpoint to a probing responder.

17. The apparatus as in claim 11, wherein the endpoint agent performing path probing comprises conducting Two-Way Active Measurement Protocol (TWAMP) probing.

18. The apparatus as in claim 11, wherein the apparatus generates the configuration based in part on the wireless endpoint being an authenticated and active client of the access point.

19. The apparatus as in claim 18, wherein the endpoint agent, based on its path probing, computes at least one of: a packet loss metric, a jitter metric, or a delay metric.

20. A tangible, non-transitory, computer-readable medium storing program instructions that cause a device to execute a process comprising:
receiving, at the device, a control request from an endpoint agent executed by a wireless endpoint in a network;
generating, by the device and based on the control request, a configuration for a particular port on an access point to which the wireless endpoint is connected;
notifying, by the device, the endpoint agent of the particular port via which the endpoint agent may perform path probing in the network; and
removing, by the device, the configuration after the endpoint agent performs the path probing via the particular port.
